(19) United States
(12) Patent Application Publication
(10) Pub. No.: US 2026/0087775 A1
(43) Pub. Date: Mar. 26, 2026

(54) OBJECT DETECTION IN SATELLITE IMAGERY USING OBJECT-SPECIFIC DATA

(71) Applicant: INTERNATIONAL BUSINESS MACHINES CORPORATION, Armonk, NY (US)

(72) Inventors: Johannes Moritz STÄBLER, Köln (DE); Fearghal O'DONNCHA, Aran Islands (IE); Johannes Walter SCHMUDE, Dobbs Ferry, NY (US); Levente KLEIN, Tuckahoe, NY (US)

(21) Appl. No.: 18/891,112

(22) Filed: Sep. 20, 2024

(51) Int. Cl. G06V 10/764; G06V 20/13

(52) U.S. Cl. CPC G06V 10/764; G06V 20/13; G06V 2201/07

(57) ABSTRACT

Imaging data is received from one or more imaging sources by a computing device over one or more networks. The imaging data is for a selected spatiotemporal dimension and indicates an object detected by at least one imaging source of the one or more imaging sources. Object-specific data for a selected type of object and for the selected spatiotemporal dimension is obtained from at least one data source. The imaging data and the object-specific data for the selected spatiotemporal dimension are processed to identify whether the object detected by the at least one imaging source is misclassified as the selected type of object. The processing employs an artificial intelligence model trained to analyze the imaging data and the object-specific data. Based on the processing, an indication of whether the object is misclassified is output.

### BACKGROUND

One or more aspects relate, in general, to improving processing within a computing environment, and in particular, to improving processing associated with remote sensing, including satellite imaging.

Remote sensing detects characteristics of an area by measuring its reflected and emitted radiation at a distance, such as from aircraft or satellites. Aircraft, satellites or other devices use cameras, sensors, etc. to take images.

Satellite imaging, as an example, is used to collect satellite images of the earth from one or more satellite imaging sources. The images may be used to visualize various conditions and to make certain decisions based thereon. For instance, images may be used to detect objects, such as buildings, vegetation, water, clouds, etc. The detection of objects is employed in making decisions, such as flight patterns, evacuation routes due to, e.g., weather conditions, and/or any other types of decisions that may benefit from satellite imagery.

### SUMMARY

Shortcomings of the prior art are overcome, and additional advantages are provided through the provision of a computer-implemented method. The computer-implemented method includes receiving, by a computing device over one or more networks, imaging data from one or more imaging sources. The imaging data is for a selected spatiotemporal dimension and indicates an object detected by at least one imaging source of the one or more imaging sources. Object-specific data for a selected type of object and for the selected spatiotemporal dimension is obtained from at least one data source. The imaging data and the object-specific data for the selected spatiotemporal dimension is processed, using, at least, the computing device, to identify whether the object detected by the at least one imaging source is misclassified as the selected type of object. The processing employs an artificial intelligence model trained to analyze the imaging data and the object-specific data. Based on the processing, an indication of whether the object is misclassified as the selected type of object is output.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2A depicts one example of satellite imagery used in accordance with one or more aspects of the present disclosure;

FIG. 2B depicts one example of a base map used in accordance with one or more aspects of the present disclosure;

FIG. 3 depicts one example of the object detection code of FIG. 1, in accordance with one or more aspects of the present disclosure;

FIG. 4 depicts one example of an object detection process, in accordance with one or more aspects of the present disclosure;

FIG. 5 depicts further details of one example of an object detection process, in accordance with one or more aspects of the present disclosure; and

FIG. 6 depicts one example of a machine learning training system used in accordance with one or more aspects of the present disclosure.

### DETAILED DESCRIPTION

In accordance with one or more aspects of the present disclosure, a capability is provided to improve processing within a computing environment. In one or more aspects, the capability includes improving object detection in images (e.g., satellite imagery) through augmentation with object-specific data (e.g., predictions, estimates, current, real-time, etc., object-specific data). In one example, an object is a visible condition, such as a cloud; other examples exist.

In one or more aspects, the technical field of remote sensing is improved by augmenting images generated by the remote sensing with object-specific data and using artificial intelligence to identify whether an object detected by the remote sensing is actually a particular object. In one example, satellite imaging is improved by augmenting satellite imagery with object-specific data (e.g., predictions, estimates, current, real-time, etc., object-specific data) and using artificial intelligence to identify whether an object detected by the satellite imaging in a spatiotemporal dimension is misclassified, meaning that the detected object classified as one type of object is, based on the combination of satellite imagery and object-specific data, a different type of object. Artificial intelligence combines satellite imagery and object-specific data to identify whether or not the detected object is properly classified.

In one or more aspects, the detection of objects in satellite imagery includes receiving the satellite imagery and detecting objects therein, obtaining object-specific data (e.g., predictions, estimates, current, real-time, etc., object-specific data) relating to a selected type of object, training an artificial intelligence (AI) model to process the satellite imagery and the object-specific data, and processing the satellite imagery and the object-specific data using the trained artificial intelligence model and/or artificial intelligence processing to indicate whether detected objects within a spatiotemporal dimension are misclassified (e.g., detected as one type of object but identified as a different type of object).

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs, e.g., object detection and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

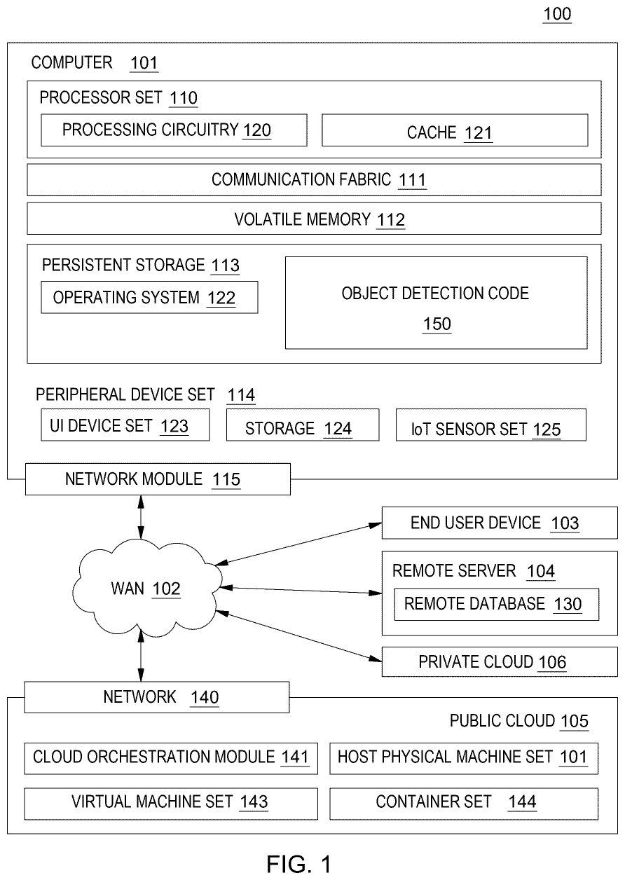

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as object detection code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

In one or more aspects, remote sensing, such as satellite imaging, is used to detect objects, such as clouds or other visible conditions. For example, multi-spectral satellite observed data, along with scene classification algorithms, are used to identify whether a cloud exists in a given pixel. However, misclassification is possible in which the algorithm identifies a cloud, but the area is actually cloud free.

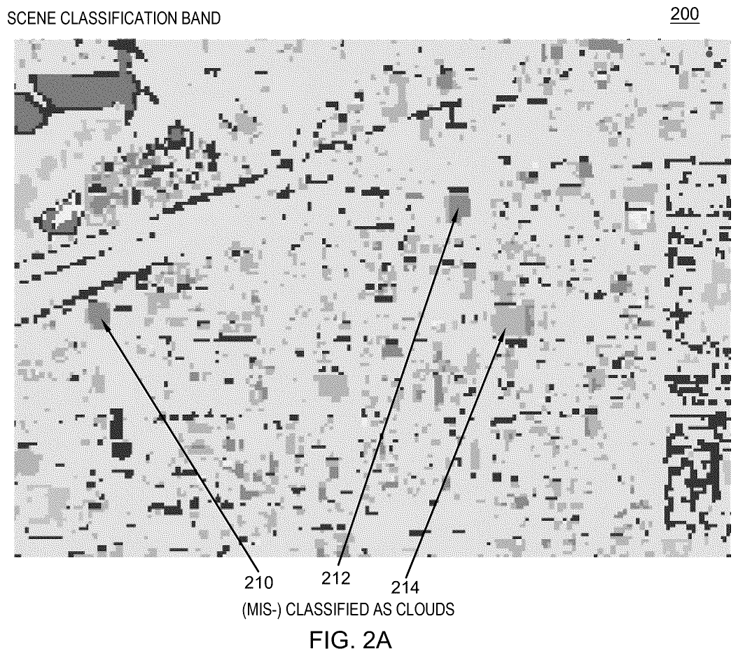

For example, as shown in FIG. 2A, a scene classification band 200 (e.g., European Space Agency's (ESA's) Sentinel-2 Level 2a scene classification band) of a multi-spectral imaging mission depicts several areas 210, 212, 214, in one example, as clouds. However, as depicted in FIG. 2B, a base map 250 indicates that areas 252, 254, 256 corresponding in a spatiotemporal dimension (e.g., a selected time and location) to areas 210, 212, 214 in FIG. 2A are buildings (e.g., with high reflective roofs) rather than clouds. Thus, conventional satellite image data processing, in this example, misclassified the detected objects as clouds.

In one or more aspects, to reduce the misclassification, satellite imagery is augmented with data that relates to the objects that are to be detected (referred to herein as object-specific data). For instance, since the detected objects are considered clouds, the object-specific data is, in one example, numerical weather data (e.g., predictions, estimates, current, real-time, etc., weather data) that indicates and/or predicts whether clouds were in one or more locations at the selected time being imaged. In one or more aspects, the satellite imagery and object-specific data (e.g., numerical weather data) are combined using artificial intelligence (e.g., a trained artificial intelligence model and/or rules) to determine whether the objects being detected by satellite imagery are, in fact, clouds or are misclassified as clouds. In one example, the numerical weather data is provided by numerical weather prediction models that use current weather conditions/observations to predict future weather conditions. The numerical weather data provides, for instance, weather-related data, such as cloud segmentation/delineation, cloud shape, cloud type, cloud speed, etc.

In one or more aspects, an artificial intelligence model is trained. For instance, one or more libraries and/or other data sources are imported and/or obtained from which data is loaded and explored for relevant data. The relevant data includes, for instance, data relating to the object to be detected, such as clouds, including, but not limited to, numerical weather data (e.g., predictions, estimates, current, real-time, etc., weather data) of e.g., cloud characteristics (e.g., shape, type, etc.), etc. The collected data is prepared including standardizing the data, replacing incorrect or missing data, enhancing and augmenting the data, etc. Using the prepared data and the learning objectives, one or more model techniques and algorithms are explored to select an appropriate model to be used. Parameters of the selected model are set and/or adjusted. Further, the model is trained.

In one example, the model is trained by using features and labels. Example features include numerical weather data (e.g., predictions, estimates, current, real-time, etc., weather data) of cloud characteristics for one or more frames; multi-spectral satellite band data; and spatiotemporal locating framework to extract numerical weather data and satellite data at corresponding spatial and temporal locations. Further, example labels include cloud presence/absence data per frame and spatially and temporally matching satellite imagery. Additional, fewer and/or other example of features and/or labels may be used.

In one example, for the features and/or labels, for historic data, inexpensive cloud detection systems (e.g., sky cameras, observations) and/or higher resolution data (e.g., spatio-temporally corresponding aerial imagery) may be used to differentiate between cloud-free and non-cloud-free timestamps. Further, in one example, a confusion matrix is obtained that includes ground truth data cloud-free/not cloud-free, and cloud detection algorithm output cloud-free/not cloud-free. A machine learning algorithm is trained using, for instance, numerical weather data (e.g., predictions, estimates, current, real-time, etc., weather data) to identify misclassified cases in the confusion matrix. Other examples and/or variations are possible.

The trained model is then evaluated using, for instance, a plurality of tests. If the evaluation indicates that further training is to be performed, then additional training is performed using, for instance, additional data, other algorithms, etc. The trained model is then used in processing, as described herein, to identify whether an object detected in imaging data is misclassified as a selected type of object. For example, the trained model is used, in one or more aspects, to identify whether a cloud detected in an image is misclassified as a cloud (i.e., it is an object other than a cloud, such as a building, etc.).

In one or more aspects, based on using the trained model and obtaining the results, the results may be used in continual training and/or retraining of the model. This allows the model to continue to learn based on the results, providing a more robust model, which learns from errors and/or corrections, as well as from correct predictions, and then may be used in further processing.

In one or more aspects, based on the detected image being correctly classified as a cloud, the type of cloud may be further classified using, e.g., deep learning techniques. For instance, cloud characteristics are generated based on combining satellite imagery and object-specific data. The cloud characteristics include, for example, cloud properties at a selected location and time, a probability of clouds at the selected location and time, and/or a cloud mask at the selected location and time. Other examples are possible.

In one or more aspects, to perform object detection, object detection code (e.g., object detection code 150) is employed. Object detection code (e.g., object detection code 150) includes code or instructions used to perform object detection processing, in accordance with one or more aspects of the present disclosure. The code is, e.g., computer-readable program code (e.g., instructions) in computer-readable media, e.g., storage (storage 124, persistent storage 113, cache 121, other storage, as examples). The computer-readable media may be part of a computer program product and the computer-readable program code may be executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the code and/or portions thereof. Many examples are possible.

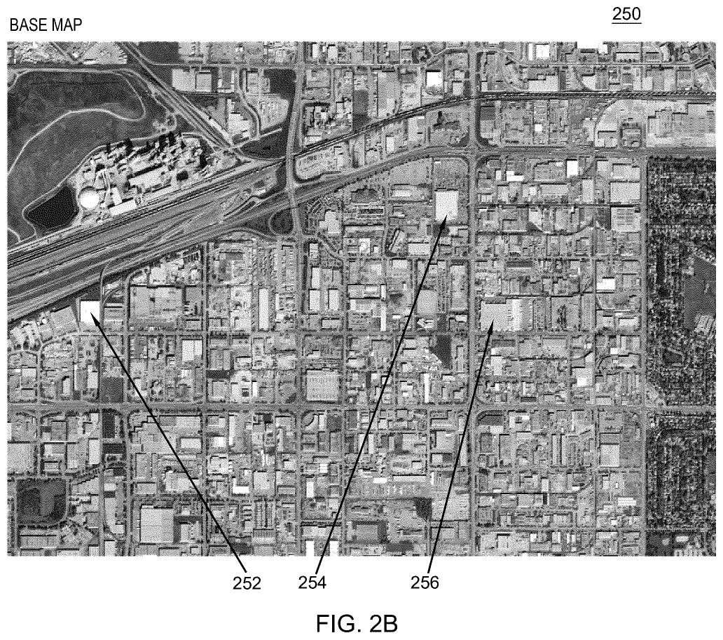

One example of object detection code 150 is described with reference to FIG. 3. In one example, object detection code 150 includes receive imaging data code 300 used to receive imaging data (e.g., images and/or data relating thereto) from one or more imaging sources (e.g., satellites) for a selected time and location (also referred to herein as spatiotemporal dimension); obtain object-specific data code 310 used to obtain data (e.g., prediction, estimates, current and/or real-time data, etc.) relating to selected types of objects at the selected time and location; process code 320 used to process the received imaging data and the obtained data using, e.g., artificial intelligence (e.g., a trained model, rules and/or processing); and training code 330 to train an artificial intelligence model to be used in the processing. Additional, less and/or other code may be provided and/or used in one or more aspects of the present invention.

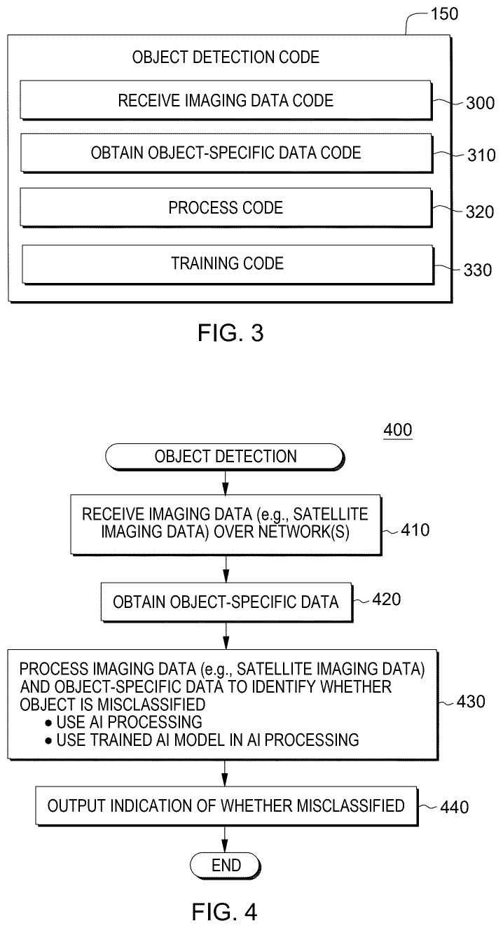

In one example, object detection code 150 includes code (e.g., code 300-330) that is used in object detection processing, as further described, in one example, with reference to FIG. 4. FIG. 4 depicts one example of an object detection process 400, which in one example, is executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the process and/or portions thereof. Many examples are possible.

Referring to FIG. 4, in one example, object detection process 400 (also referred to as process 400) includes receiving 410 (e.g., using receive imaging data code 300), over one or more networks, imaging data. The imaging data is received from one or more imaging sources. As examples, the imaging sources include one or more satellites, and the imaging data includes scene classification band data (e.g., scene images and/or data relating thereto) and/or multi-spectral band data (e.g., multi-spectral band satellite data—e.g., satellite images taken for different spectral bands and/or data relating thereto). Other examples of imaging data are possible.

In one example, the imaging data indicates (e.g., includes a depiction or representation thereof and/or describes) one or more objects detected by at least one imaging source of one or more imaging sources. An object may be a building, vegetation, water, cloud, any visible condition, etc. In the example herein, the objects of interest are clouds; however, other examples are possible.

In one or more aspects, process 400 obtains 420 (e.g., using obtain object-specific data code 310) object-specific data for a selected type of object at one or more selected times and one or more locations. For example, the object-specific data is data (e.g., predicted, estimated, current, real-time, etc.) for clouds and includes, for example, cloud characteristics, weather conditions, etc.

Process 400 processes 430 (e.g., using process code 320) the received imaging data (e.g., satellite imaging data) and the obtained object-specific data to identify whether an object detected in the imaging data at a selected time and location and classified as the selected type of object is, in fact, misclassified. For instance, the processing identifies whether the object detected in the imaging data at the selected time and location and classified as a cloud is misclassified and is not a cloud. Instead, it may be another object, such as a building.

In one example, the processing uses artificial intelligence (e.g., rule-based and/or machine learning-based artificial intelligence) to combine the imaging data (e.g., satellite imaging data) and the object-specific data (e.g., numerical weather data) to identify cloud-free areas (or other object-free areas) and land cover in a satellite image. The artificial intelligence processing may include: ensemble modeling incorporating satellite (e.g., cloud type classification and probability) and object-specific data (e.g., numerical weather data (e.g., predictions, estimates, current, real-time, etc., weather data) of, e.g., cloud presence, cloud characteristics, and probability)—i.e., combine the relative probability estimate by satellite and object-specific data; and/or multi-modal modeling in which the prediction and probability of object-specific data (e.g., numerical weather data (e.g., predictions, estimates, current, real-time, etc., weather data)) are infused together with observation and probability from satellite estimates into a machine learning algorithm (e.g., neural network) detecting object (e.g., cloud) pixels in satellite data.

Based on the processing, in one example, process 400 outputs 440 an indication of whether the detected object was misclassified. For instance, an indication is provided as to whether the detected object is a cloud. Other examples are possible.

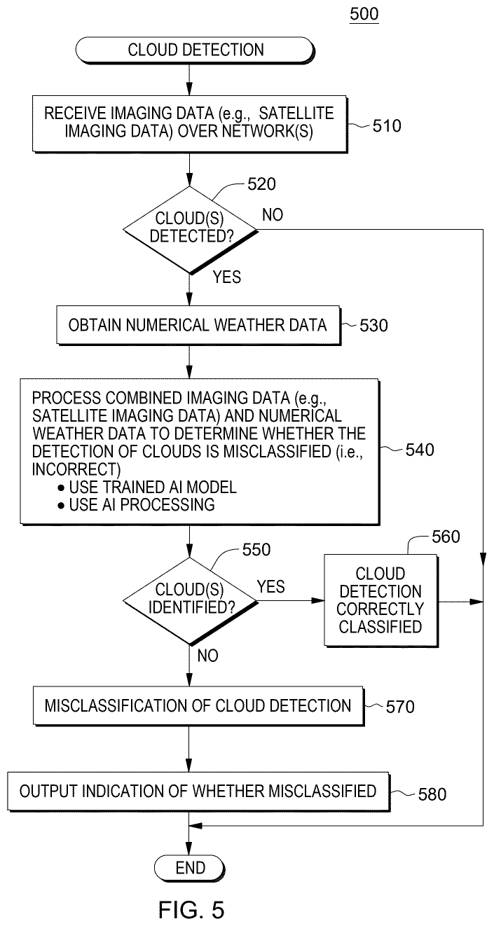

Further details of one example of an object detection process are described with reference to FIG. 5. In this example, the selected type of object is a cloud, and the object-specific data is numerical weather data (e.g., predictions, estimates, current, real-time, etc., weather data); other examples are possible. In one example, a cloud detection process 500 is executed by and/or using one or more computing devices (e.g., one or more computers, such as computer(s) 101; one or more servers, such as remote server(s) 104; one or more processors or nodes, such as processor(s) or node(s) of processor set 110; processing circuitry, such as processing circuitry 120 of processor set 110; and/or other computing devices, etc.). Additional and/or other computing devices, computers, servers, processors, nodes and/or processing circuitry may be used to execute the process and/or portions thereof. Many examples are possible.

Referring to FIG. 5, in one example, cloud detection process 500 (also referred to as process 500) includes receiving 510 (e.g., using receive imaging data code 300), over one or more networks, imaging data. The imaging data is received from one or more imaging sources. As examples, the imaging sources include one or more satellites, and the imaging data includes scene classification band data (e.g., scene images and/or data relating thereto) and/or multi-spectral band data (e.g., multi-spectral band satellite data—e.g., satellite images taken for different spectral bands and/or data relating thereto). In one particular example, the source of the imagery and scene classification is ESA Sentinel-2 imagery of Edmonton, 2021-11-02 (53.5752523/−113.5865681); however, other imagery and/or classifications from the same source and/or different sources may be used. Other examples of imaging data are possible.

In one example, the imaging data indicates (e.g., includes a depiction or representation thereof and/or describes) one or more clouds detected by at least one imaging source of one or more imaging sources (e.g., satellites). Other examples are possible.

Process 500 determines 520, in one example, whether one or more clouds are detected in the imaging data. This determining includes, for instance, using rules relating to specific bands of a scene classification and selected object types. For instance, a cloud mask is generated by executing a plurality of rules for particular bands (e.g., check if band 4 is greater than a selected value; check if a normalized difference snow index is greater than a particular value; check other band values, etc.). Based on generating the cloud mask, the cloud mask is used to determine whether any clouds were detected.

If no clouds are detected, processing is complete. However, if one or more clouds are detected, then processing continues to identify whether the detection of the clouds is a misclassification, and instead, the spatiotemporal dimension is free from clouds.

Based on one or more clouds being detected, process 500 obtains 530 (e.g., using obtain object-specific data code 310) object-specific data, such as numerical weather data (e.g., predictions, estimates, current, real-time, etc., weather data) for one or more selected times and one or more locations. The one or more selected times and one or more locations include, at least, the selected time and location of the imaging data. In one example, the numerical weather data (e.g., predictions, estimates, current, real-time, etc., weather data) is for a frame (e.g., a plurality of pixels) rather than for an individual pixel.

In one particular example, the object-specific data is numerical weather prediction cloud cover data for, e.g., 2021-11-02 provided by, e.g., ERA5 (ECMWF Reanalysis v5) produced by the Copernicus Climate Change Service at the ECMWF (European Centre for Medium-Range Weather Forecasts). Additional and/or other sources of numerical weather prediction data and/or additional and/or other numerical weather prediction data and/or additional and/or other object-specific data may be obtained.

In one example, the imaging data and/or the object-specific data is averaged across a selected time period (e.g., 24 hours) from, e.g., hourly data or from another time period.

Process 500 processes 540 (e.g., using process code 320) the received imaging data (e.g., satellite imaging data) and the numerical weather data (e.g., predictions, estimates, current, real-time, etc., weather data) to identify whether the detection of clouds in the selected time and location is misclassified (i.e., incorrect). In one example, the processing uses artificial intelligence (e.g., rule-based or machine learning-based artificial intelligence) to combine the satellite imaging data and the numerical weather data (e.g., predictions, estimates, current, real-time, etc., weather data) to identify cloud-free (or other object-free) areas and land cover in a satellite image. The artificial intelligence processing may include: ensemble modeling incorporating satellite (e.g., cloud type classification and probability) and object-specific data (e.g., numerical weather data (e.g., predictions, estimates, current, real-time, etc., weather data) of, e.g., cloud presence, cloud characteristics, and probability)—i.e., combine the relative probability estimate by satellite and object-specific data; and/or multi-modal modeling in which the prediction and probability of object-specific data (e.g., numerical weather data (e.g., predictions, estimates, current, real-time, etc., weather data) are infused together with observation and probability from satellite estimates into a machine learning algorithm (e.g., neural network) detecting object (e.g., cloud) pixels in satellite data.

In one example, the object-specific data provides a probability of whether clouds were in the spatiotemporal dimension. That probability is used with the cloud mask to determine 550 whether clouds were identified in the area or whether the area was cloud-free (i.e., clouds were misclassified in the imaging data). As examples, the cloud probabilities (and/or other probabilities from the numerical weather data (e.g., predictions, estimates, current, real-time, etc., weather data)) may be matched by a simple multiplication/knife edge or a trained super learner machine learning model. Additional, fewer and/or other examples are possible.

In one example, if the object-specific data indicates a zero or near zero percent chance of clouds at the time and location that the imaging data was obtained, then the time and location is considered cloud-free, even if the cloud mask indicates clouds. However, in other examples, in which the probability is above zero, one or more approaches (e.g., simple multiplication/knife edge or a trained super learner machine learning model) are used to determine whether a cloud mask indicating clouds is misclassifying the imaging data.

Based on the processing indicating 560 that one or more clouds were identified (i.e., the classification is accurate), then process 500 outputs 580 an indication that the cloud detection is correctly classified, and processing is complete. However, if the processing indicates 570 that the clouds were misclassified, then process 500 outputs 580 an indication that the cloud detection is misclassified, and processing is complete.

In one or more aspects, based on the results (e.g., a misclassification or correct classification), the artificial intelligence model may be retrained using the latest data. By retraining the model with the latest data, the model becomes more robust. The processing may then be re-executed using the retrained model to determine if the results are the same. If not, action is taken to further train and/or optimize the model and/or the artificial intelligence processing in order to improve cloud detection within satellite imagery.

By improving cloud detection, such that there are fewer misclassifications, technologies and/or industries relying on cloud detection, such as aviation (e.g., flight patterns, etc.); transportation (e.g., evacuation routes, etc.); construction; agricultural; utilities; energy production; etc., are improved. For instance, by correctly identifying buildings, rather than having them mislabeled as clouds, various technologies may be improved, including but not limited to, urban planning, transportation, aviation, etc. Further, by obtaining improved real-time data of whether an area is cloud-free may improve various technologies, including, but not limited to agriculture. Many examples are possible.

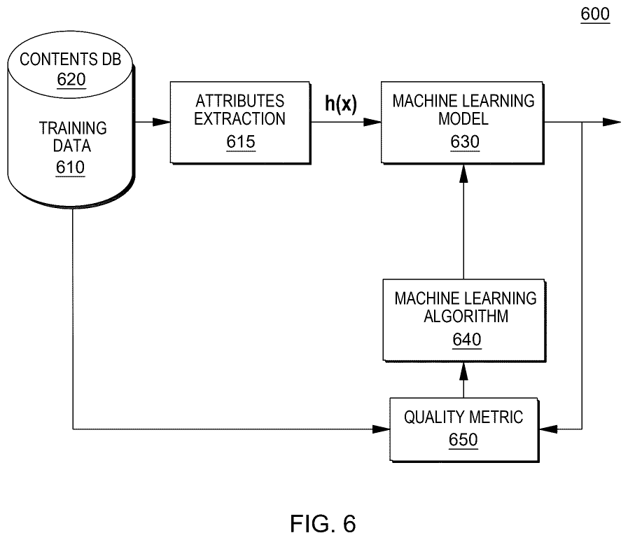

As described herein, one or more aspects may use machine learning. One example of a machine learning training system is described with reference to FIG. 6. In one or more aspects, a machine learning training system 600 may be utilized to perform cognitive analyses of various inputs, including input data (e.g., imaging data, object-specific data, etc.), data from one or more data structures and/or other data. Training data utilized to train the model in one or more embodiments of the present disclosure includes, for instance, data that pertains to one or more events, such as natural language processing data, record data being processed, imaging data, object-specific data (e.g., weather related data, etc.), etc. The program code in embodiments of the present disclosure performs a cognitive analysis to generate one or more training data structures, including algorithms utilized by the program code to predict states of a given event (e.g., clouds, no clouds). Machine learning (ML) solves problems that are not solved with numerical means alone. In this ML-based example, program code extracts various attributes from ML training data 610 (e.g., historical attribute data (e.g., weather related data, imaging data, etc.) collected from various data sources relevant to the event), which may be resident in one or more databases 620 comprising event or task-related data and general data. Attributes 615 are utilized to develop a predictor function, h(x), also referred to as a hypothesis, which the program code utilizes as a machine learning model 630.

In identifying various event states, features, attribute similarities, constraints and/or behaviors indicative of states in the ML training data 610, the program code can utilize various techniques to identify attributes in an embodiment of the present disclosure. Embodiments of the present disclosure utilize varying techniques to select attributes (data attributes (e.g., weather data attributes, other attributes, etc.), characteristics (e.g., weather data characteristics, other characteristics, etc.), elements, patterns, features, constraints, distribution, etc.), including but not limited to, diffusion mapping, principal component analysis, recursive feature elimination (a brute force approach to selecting attributes), and/or a Random Forest, to select the attributes related to various events (e.g., weather, clouds, etc.). The program code may utilize a machine learning algorithm 640 to train the machine learning model 630 (e.g., the algorithms utilized by the program code), including providing weights for the conclusions, so that the program code can train the predictor functions that comprise the machine learning model 630. The conclusions may be evaluated by a quality metric 650. By selecting a diverse set of ML training data 610, the program code trains the machine learning model 630 to identify and weight various attributes (e.g., data attributes, characteristics, features, patterns, constraints, distributions, etc.) that correlate to various states of an event.

The model generated by the program code is self-learning as the program code updates the model based on active event feedback, as well as from the feedback received from data related to the event. For example, when the program code determines that there is a constraint, event, similarity or pattern (e.g., object identified, data attribute, record attribute similarity, query pattern, data distribution, search terms distribution, etc.) that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources (e.g., imaging data, object-specific data, etc.). In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, images, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data (e.g., weather data, imaging data) to generate the model utilized to predict the state of a given event (e.g., cloud-free area) at a given time. Neural networks are biologically-inspired programming paradigms, which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns (or similarities) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event (e.g., clouds/no clouds).

In one or more aspects, object detection in remote sensing (e.g., satellite imagery) is improved through the use of object-specific data (e.g., predictions, estimates, current, real-time, etc., object-specific data). As one example, the object detection includes the detection of clouds in satellite imagery, which is improved through augmentation with numerical weather data. In one or more aspects, the detection of objects in satellite imagery includes receiving the satellite imagery and detecting objects therein, obtaining object-specific data relating to the objects, training an artificial intelligence (AI) model to process the satellite imagery and the object-specific data, and processing the satellite imagery and the object-specific data using the trained artificial intelligence model and/or artificial intelligence processing to indicate whether detected objects within a spatiotemporal region are misclassified (e.g., detection as one type of object but identified as a different type of object).

One or more aspects include a capability to improve satellite land-surface observations based on a more robust cloud object detection algorithm informed by, e.g., numerical weather data (e.g., numerical weather prediction (NWP)). One or more aspects include: multi-spectral satellite observed data that is used to identify whether a cloud exists or not in a given pixel, cloud type can be classified using a deep learning technique; cloud segmentation, delineation, shape, type, and movement details extracted from numerical weather prediction models (used to process current weather conditions/observations to predict future weather conditions) which provide a physical determination of cloud movement based on, e.g., wind direction and speed at different altitudes; spatiotemporal matching of weather and satellite data for a given location and extraction of pertinent data at those points; extraction of cloud detection metrics from satellite data (e.g., scene classification) and cloud characteristics and probability values from numerical weather prediction models; and/or an artificial intelligence and/or rule-based approach that combines data from satellite and numerical weather prediction models to identify cloud free areas and land cover in a satellite image (create a cloud mask). For example, ensemble modeling incorporating satellite (cloud type classification and probability) and numerical weather data (cloud presence, cloud characteristics, and probability)—i.e. combine the relative probability estimate by satellite and numerical weather data; and/or foundational model based approach, where satellite and numerical weather data are corrected using complementary information from the multi-modal sensing where the prediction and probability of numerical weather data are infused together with the observation and probability from satellite estimate into a machine learning algorithm (e.g. neural network) detecting cloud pixels in a satellite data and correcting/updating the numerical weather data.

In one or more aspects, the inputs to an object detection process (e.g., to determine whether a spatiotemporal dimension is cloud-free) include numerical weather data (e.g., predictions, estimates, current, real-time, etc., weather data—e.g., of cloud probabilities); multi-spectral satellite band data or scene classification band data; and a trained machine learning or rule-based technique to process the numerical weather data and satellite data and to output updated cloud characteristics (e.g., type, such as cirrus; shape; height; etc.). Outputs of the object detection process, in one example, include a cloud mask for a selected time and location, and optionally, cloud properties at the selected time and location (e.g., shape, height, type) and/or cloud probabilities at the selected time and location. The cloud mask indicates for each pixel (or selected pixels) of the imaging data whether it is a cloud or not.

In one or more aspects, weather-related data (e.g., cloud segmentation/delineation, cloud shape, cloud type, cloud speed, etc.) is obtained hourly (or at other selected times) from one or more numerical weather prediction models that use current weather observations/conditions to predict future weather conditions. The weather-related data (e.g., obtained from one or more numerical weather prediction models) is used, in one example, to calculate the position of clouds at selected timestamps.

Further, in one example, daily (or other selected time periods) satellite image data is collected and used to determine, for instance, a cloud mask and/or cloud segmentation.

A determination is made as to whether the time periods of the numerical weather data and the satellite imagery are synchronized. If not, updated numerical weather data is obtained. Otherwise, using a combination of the numerical weather data and the satellite imagery (e.g., cloud mask and/or cloud segmentation), cloud location, cloud type and/or cloud height for a selected time and location are determined. A determination is made, in one example, as to whether the cloud mask produced from the satellite image data is correct based on the numerical weather data. If not, the cloud mask is corrected, in one example. This provides an indication of whether a selected location is cloud-free.

One or more aspects of the present invention are tied to computer technology and facilitate processing within a computer, improving performance thereof. In one or more aspects, the technical field of remote sensing (including satellite imaging) and processing thereof are improved by improving the detection of selected objects, such as clouds. One or more aspects improve current cloud detection plausibility based on estimated weather conditions from numerical weather data (e.g., using numerical weather prediction models); e.g., a current challenge is that satellite imagery may not resolve a given field or location due to the presence of clouds while no cloud is actually there (inaccurate cloud masking). One or more aspects extend existing satellite-based cloud detection algorithms from purely computer vision-based by augmenting with external data; and/or can be extended with other external cloud detection datasets (if suitable time localization can be achieved to coincide with satellite flyovers). Other examples are possible.

One or more aspects augment the computer vision aspect of cloud detection in remote sensing by the non-computer vision aspect of including numeric weather data (e.g., predictions, estimates, current, real-time, etc., weather data). For instance, numeric weather data informs physics-based rather than computer vision-based: whether clouds can be expected, and if there are clouds, optionally, one or more characteristics, such as which shape, and at which height, are they expected to occur in. One or more aspects of the present disclosure include one or more of those characteristics in identifying clouds on satellite and aerial imagery to help enhance the certainty, hence accuracy, of cloud detection beyond levels expected by computer-vision alone.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Although various embodiments are described above, these are only examples. For example, other models and/or weather data may be used. Moreover, additional, less and/or other code may be used. Although particular code may be provided as an example of performing a particular operation or task, additional and/or other code may be used. Code may be combined and/or separated into code subsets. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
receiving, by a computing device over one or more networks, imaging data from one or more imaging sources, the imaging data being for a selected spatiotemporal dimension and indicating an object detected by at least one imaging source of the one or more imaging sources;
obtaining from at least one data source object-specific data for a selected type of object and for the selected spatiotemporal dimension;
processing, using, at least, the computing device, the imaging data and the object-specific data for the selected spatiotemporal dimension to identify whether the object detected by the at least one imaging source is misclassified as the selected type of object, the processing employing an artificial intelligence model trained to analyze the imaging data and the object-specific data; and
outputting, based on the processing, an indication of whether the object is misclassified.

2. The computer-implemented method of claim 1, wherein the object detected by the at least one imaging source is classified as a cloud and the object-specific data includes numerical weather data.

3. The computer-implemented method of claim 1, wherein the processing uses artificial intelligence rule-based processing to perform spatiotemporal matching of the imaging data and the object-specific data to identify whether the object detected in the selected spatiotemporal dimension is misclassified as the selected type of object.

4. The computer-implemented method of claim 1, further comprising training the artificial intelligence model using historical imaging data and historical object-specific data for one or more spatiotemporal dimensions.

5. The computer-implemented method of claim 4, further comprising:
determining that the artificial intelligence model is producing one or more errors; and
retraining the artificial intelligence model using current imaging data and current object-specific data to provide a retrained artificial intelligence model to be used in the processing.

6. The computer-implemented method of claim 1, wherein the one or more imaging sources include one or more satellites, and the imaging data includes multi-spectral band data generated from one or more images provided by the one or more satellites.

7. The computer-implemented method of claim 1, wherein the one or more imaging sources include one or more satellites, and the imaging data includes scene classification band data generated from one or more images provided by the one or more satellites.

8. The computer-implemented method of claim 1, further comprising generating one or more object characteristics based on combining the imaging data and the object-specific data.

9. The computer-implemented method of claim 8, wherein the object detected by the at least one imaging source is a cloud and the one or more object characteristics include one or more cloud characteristics.

10. The computer-implemented method of claim 9, wherein the one or more cloud characteristics include one or more properties of the cloud at a selected location and time.

11. A computer system comprising:
at least one computing device;
a set of one or more computer-readable storage media; and
program instructions, collectively stored in the set of one or more computer-readable storage media, for causing the at least one computing device to perform computer operations including:
receiving, by a computing device of the at least one computing device over one or more networks, imaging data from one or more imaging sources, the imaging data being for a selected spatiotemporal dimension and indicating an object detected by at least one imaging source of the one or more imaging sources;
obtaining, from at least one data source, object-specific data for a selected type of object and for the selected spatiotemporal dimension;
processing, using, at least, the computing device, the imaging data and the object-specific data for the selected spatiotemporal dimension to identify whether the object detected by the at least one imaging source is misclassified as the selected type of object, the processing employing an artificial intelligence model trained to analyze the imaging data and the object-specific data; and
outputting, by the computing device based on the processing, an indication of whether the object is misclassified.

12. The computer system of claim 11, wherein the object detected by the at least one imaging source is classified as a cloud and the object-specific data includes numerical weather data.

13. The computer system of claim 11, wherein the one or more imaging sources include one or more satellites, and the imaging data includes multi-spectral band data generated from one or more images provided by the one or more satellites.

14. The computer system of claim 11, wherein the one or more imaging sources include one or more satellites, and the imaging data includes scene classification band data generated from one or more images provided by the one or more satellites.

15. The computer system of claim 11, wherein the computer operations further comprise generating one or more object characteristics based on combining the imaging data and the object-specific data, wherein the object detected by the at least one imaging source is a cloud and the one or more object characteristics include one or more cloud characteristics.

16. A computer program product comprising:
a set of one or more computer-readable storage media; and
program instructions, collectively stored in the set of one or more computer-readable storage media, for causing at least one computing device to perform computer operations including:
receiving, by a computing device of the at least one computing device over one or more networks, imaging data from one or more imaging sources, the imaging data being for a selected spatiotemporal dimension and indicating an object detected by at least one imaging source of the one or more imaging sources;
obtaining, from at least one data source, object-specific data for a selected type of object and for the selected spatiotemporal dimension;
processing, using, at least, the computing device, the imaging data and the object-specific data for the selected spatiotemporal dimension to identify whether the object detected by the at least one imaging source is misclassified as the selected type of object, the processing employing an artificial intelligence model trained to analyze the imaging data and the object-specific data; and
outputting, based on the processing, an indication of whether the object is misclassified.

17. The computer program product of claim 16, wherein the object detected by the at least one imaging source is classified as a cloud and the object-specific data includes numerical weather data.

18. The computer program product of claim 16, wherein the one or more imaging sources include one or more satellites, and the imaging data includes multi-spectral band data generated from one or more images provided by the one or more satellites.

19. The computer program product of claim 16, wherein the one or more imaging sources include one or more satellites, and the imaging data includes scene classification band data generated from one or more images provided by the one or more satellites.

20. The computer program product of claim 16, wherein the computer operations further comprise generating one or more object characteristics based on combining the imaging data and the object-specific data, wherein the object detected by the at least one imaging source is a cloud and the one or more object characteristics include one or more cloud characteristics.
